(19) United States
(12) Patent Application Publication
(10) Pub. No.: US 2025/0370827 A1
(43) Pub. Date: Dec. 4, 2025

(54) Non-Transitory Computer-Readable Medium, Method, Apparatus and Device for a Computer System

(71) Applicants: Zhiyin CHEN, Shanghai (CN); Nanhai ZOU, Shanghai (CN); Gang DENG, Beijing (CN); Jixing GU, Shanghai (CN); Wei LI, Shanghai (CN); Jun JIN, Shanghai (CN); Qihua DAI, Shanghai (CN)

(72) Inventors: Zhiyin CHEN, Shanghai (CN); Nanhai ZOU, Shanghai (CN); Gang DENG, Beijing (CN); Jixing GU, Shanghai (CN); Wei LI, Shanghai (CN); Jun JIN, Shanghai (CN); Qihua DAI, Shanghai (CN)

(21) Appl. No.: 19/305,818

(22) Filed: Aug. 21, 2025

(30) Foreign Application Priority Data
Aug. 22, 2024 (WO) PCT/CN2024/114031

(51) Int. Cl. G06F 9/52

(52) U.S. Cl. CPC G06F 9/526

(57) ABSTRACT

Some aspects of the present disclosure relate to a non-transitory computer-readable medium storing instructions that, when executed by one or more processor circuitries, cause the one or more processor circuitries to perform a method for a computer system, comprising attempting to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system, and performing a read or write access to the variable if the read or write lock is successfully obtained.

### BACKGROUND

Reader-Writer (RW) lock is one of the most important and fundamental synchronization primitives today. Reads and writes are two kinds of typical operations on shared objects (such as files, tables, and some other data) in a parallel and distributed computing system. Different readers can access the shared object concurrently, while writers need to require exclusive access. An RW lock can synchronize the read/write operations such that multiple threads hold the lock simultaneously in read mode, and exactly one thread holds the lock in write mode.

### BRIEF DESCRIPTION OF THE FIGURES

Some examples of apparatuses and/or methods will be described in the following by way of example only, and with reference to the accompanying figures, in which:

FIG. 1 shows pseudocode for a read procedure and a write procedure;

FIG. 2 shows a schematic diagram of a data structure for read/write counters used in a reader/writer lock;

FIG. 3 shows pseudocode for acquiring a reader/writer lock according to a conventional reader/writer locking scheme;

FIGS. 4a and 4b show flow charts for reader-writer lock acquisition contention in CAS for two cases;

FIG. 5a shows a schematic diagram of an apparatus or device for a computer system;

FIG. 5b shows a flow chart of a method for a computer system;

FIG. 6a shows a schematic diagram of a data structure for read/write counters for a basic RW lock;

FIG. 6b shows a schematic diagram of a data structure for read/write counters for a fair RW lock;

FIG. 7 shows pseudocode for acquisition of a RW lock;

FIGS. 8 and 9 show diagrams of benchmarks;

FIG. 10 shows a block diagram of an electronic apparatus;

FIG. 11 illustrates a computing device; and

FIG. 12 illustrates a computing system.

### DETAILED DESCRIPTION

Some examples are now described in more detail with reference to the enclosed figures. However, other possible examples are not limited to the features of these examples described in detail. Other examples may include modifications of the features, as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

When two elements A and B are combined using an “or”, this is to be understood as disclosing all possible combinations, i.e., only A, only B, as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an”, and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise”, and/or “comprising”, when used, describe the presence of the specified features, integers, steps, operations, processes, elements, components, and/or a group thereof, but do not exclude the presence or addition of one or more other features, integers, steps, operations, processes, elements, components, and/or a group thereof.

Unless otherwise defined, all terms (including technical and scientific terms) are used herein in their ordinary meaning in the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply the element so described must be in a given sequence, either temporally or spatially, in ranking, or any other manner. “Connected” may indicate elements are in direct physical or electrical contact with each other, and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Reader-Writer locks (RW locks) are widely used in different scenarios, such as operating system kernels, databases, high-performance computing, and web applications.

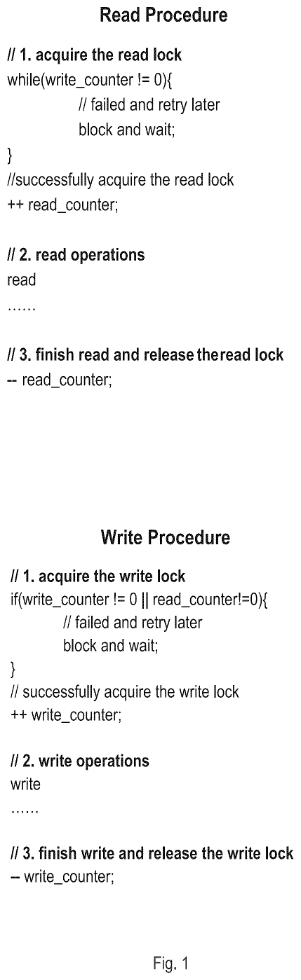

FIG. 1 shows pseudocode for a read procedure/operation and a write procedure operation. In the read/write procedure, read/write counters are used to calculate the number of threads that hold the lock. If too many threads on a multi-core server contend for the RW lock, the read/write counters can be accessed frequently, and the latest value of the counters may be synchronized between different cores repeatedly. This can result in a performance bottleneck if the RW lock contention is heavy. As a result, the acquisition of RW locks is significant to the scalability of the applications.

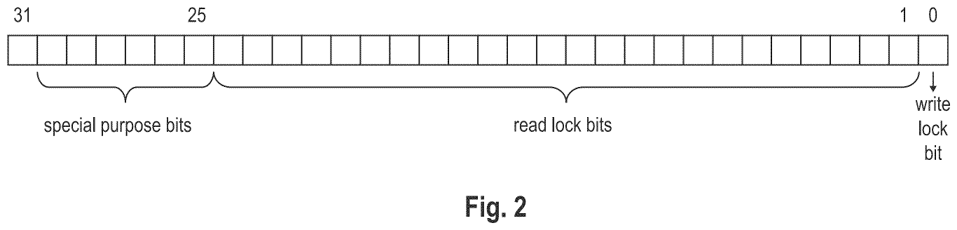

Generally, a shared atomic variable records the current state of the RW lock, which contains the read/write counters and some other information. The state of the RW lock determines whether the read/write threads acquire the lock successfully or need to be blocked and wait. Different kinds of RW locks have different conditions to acquire the lock. A typical 32-bit shared variable structure is shown as the original lock in FIG. 2. FIG. 2 shows a schematic diagram of a data structure for read/write counters used in a reader/writer lock. The 31st bit is reserved. Bits 25-30 are special purpose bits. Bits 1-24 represent the count of read threads that hold the lock. The 0th bit denotes the count of write threads that hold the lock.

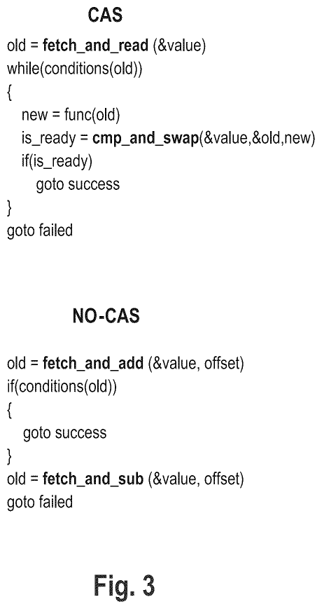

There are two approaches to updating the shared atomic variable and acquiring the RW lock, namely CAS (Compare And Swap) and NO-CAS (No Compare And Swap). The operations are shown in FIG. 3. FIG. 3 shows code for acquiring a reader/writer lock according to a conventional reader/writer locking scheme, with CAS shown on the top and NO-CAS shown on the bottom.

In other systems, compare-and-swap (CAS) is the most common atomic instruction to update counters of RW locks. To acquire a read lock and update the corresponding counter, the general operations are performed. First (1), the atomic shared variable, which represents the current state of the RW lock, is fetched and read. Then (2), a check is performed as to whether the RW lock is held by a writer or not. When another writing thread holds the lock, the reading threads fail to acquire the lock and must wait for reading until the writing thread frees the lock. Then (3), the new value of the atomic shared variable is calculated, such that the read counter records the current reading thread. Then (4), the atomic shared variable is updated according to the calculated result from the previous operation (3). To avoid other threads that may have changed the atomic shared variable after the first operation, and to ensure that the calculated result is the correct value, CAS is applied here. (5) If the thread fails to update the shared variable, it returns to (2) and retries. Else, it succeeds in acquiring the lock.

Moreover, in some other systems, such as RWSEM (Read-Write Semaphore) in the Linux Kernel, the read counter is updated without CAS. When a read task is incoming, the thread applies the atomic instruction “fetch_and_add” and optimistically updates the read counter without any check. The atomic instruction can return the old value of the RW-lock state. Then, the old value can be checked. If it satisfies specific conditions (such as that the write counter is zero), the read thread is successful in acquiring a read lock. If not, the read thread just needs to correct the read counter by “fetch_and_sub” and be blocked to wait for the lock.

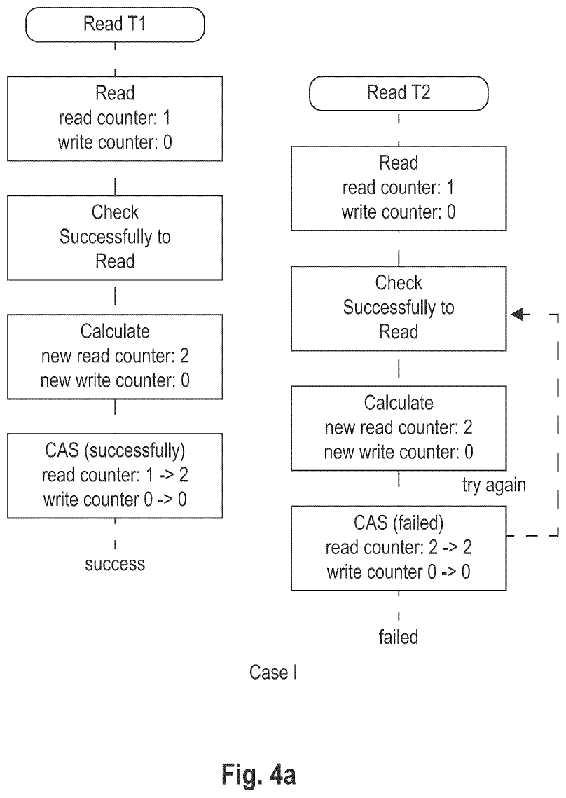

Using CAS may have drawbacks. In the operations of CAS, it is easy to find that operations 1-4 can be seen as an atomic operation. If there are too many concurrent reading threads in these steps, they may have to return to step 2 from step 4 repeatedly. FIGS. 4a and 4b show flow charts for RW lock acquisition contention in CAS for two cases. As shown in FIGS. 4a and 4b, two cases are shown to illustrate how different read/write threads conflict.

In the first case, thread T2 needs to update the read counter from 1 to 2. However, it fails because the read counter has been updated to 2 by thread T1. Then, thread T2 must try again and update the read counter from 2 to 3. Similarly, in the second case, thread T2 also failed to update the read counter. After trying again, it finds the lock has been held by a write thread, and it must wait until the write thread frees the lock.

Using NO-CAS may also have drawbacks. Generally, NO-CAS is used only for the update of read counters. Since the counter update can be revoked due to conflicts between read and write operations, NO-CAS can work effectively in read-intensive scenarios. However, in write-intensive scenarios, NO-CAS may frequently encounter failures and must correct and update the counter repeatedly, which downgrades the performance.

As a result, in CAS and NO-CAS, the counters need to be checked and updated individually, in order. However, in parallel and distributed computing scenarios, different threads can conflict with each other unless the counters can be checked and updated with one atomic instruction.

The present disclosure provides an improved RW lock design that may use the CMPccXADD instruction, simplifying RW lock acquirement with reduced CPU cycle costs, to improve scalability and improve RW lock performance for high-core systems.

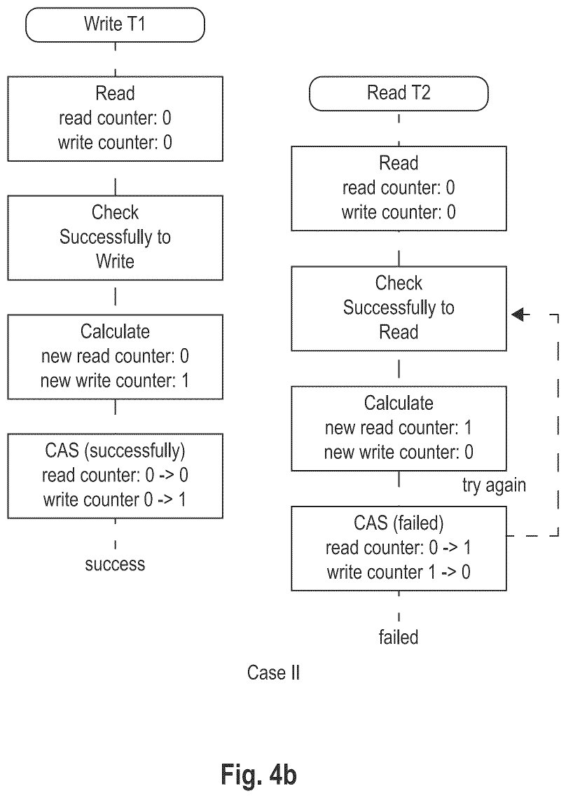

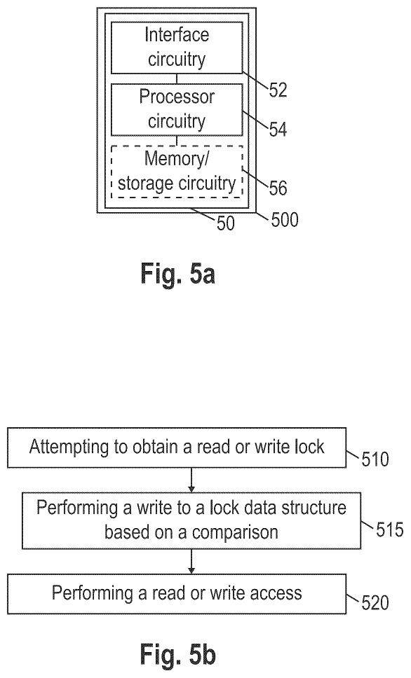

FIG. 5a shows a schematic diagram of an apparatus 50 or device 50 for a computer system 500 and of a computer system 500 comprising such an apparatus 50 or device 50. The apparatus 50 comprises circuitry to provide the functionality of the apparatus 50. For example, the circuitry of the apparatus 50 may be configured to provide the functionality of the apparatus 50. For example, the apparatus 50 of FIG. 5a comprises interface circuitry 52, processor circuitry 54, and (optional) memory/storage circuitry 56. For example, the processor circuitry 54 may be coupled with the interface circuitry 52 and/or with the memory/storage circuitry 56. For example, the processor circuitry 54 may provide the functionality of the apparatus, in conjunction with the interface circuitry 52 (for communicating with other entities inside or outside the computer system 500), and the memory/storage circuitry 56 (for storing information, such as machine-readable instructions). Likewise, the device 50 may comprise means for providing the functionality of the device 50. For example, the means may be configured to provide the functionality of the device 50. The components of the device 50 are defined as component means, which may correspond to, or be implemented by, the respective structural components of the apparatus 50. For example, the device 50 of FIG. 5a comprises means for processing 54, which may correspond to or be implemented by the processor circuitry 54, means for communicating 52, which may correspond to or be implemented by the interface circuitry 52, (optional) means for storing information 56, which may correspond to or be implemented by the memory or storage circuitry 56. In general, the functionality of the processor circuitry 54 or means for processing 54 may be implemented by the processor circuitry 54 or means for processing 54 executing machine-readable instructions. Accordingly, any feature ascribed to the processor circuitry 54 or means for processing 54 may be defined by one or more instructions of a plurality of machine-readable instructions. The apparatus 50 or device 50 may comprise the machine-readable instructions, e.g., within the memory or storage circuitry 56 or means for storing information 56.

For example, the interface circuitry 52 or means for communicating 52 corresponds to one or more inputs and/or outputs designed to receive and/or transmit information. This information can be in digital (bit) values according to a specified code, whether exchanged within a module, between different modules, or even between modules of distinct entities. For example, the interface circuitry 52 or means for communicating 52 may include interface circuitry configured to handle the reception and/or transmission of such information.

For example, the processing circuitry 54 or means for processing 54 can be implemented using one or more processing units, processing devices, or any means for processing, such as a processor, a computer, or a programmable hardware component equipped with appropriately adapted software. Thus, the described function of the processing circuitry 54 or means for processing 54 can be executed in software, running on one or more programmable hardware components. Such components may include a general-purpose processor, a Digital Signal Processor (DSP), a microcontroller, or more.

For example, the memory/storage circuitry 56 or means for storing information 56 may comprise at least one element of the group of a computer readable storage medium, such as a magnetic or optical storage medium, e.g., a hard disk drive, a flash memory, floppy disk, Random Access Memory (RAM), Programmable Read Only Memory (PROM), Erasable Programmable Read Only Memory (EPROM), an Electronically Erasable Programmable Read Only Memory (EEPROM), or a network storage.

The processor circuitry 54 or means for processing 54 is to attempt to obtain a read or write lock for accessing a variable, by performing a write to a lock data structure (e.g., a lock data structure of a Readers-Writer-lock) based on a comparison between the lock data structure and at least one pre-defined condition. The comparison and the write are performed together using a single instruction offered by an instruction set architecture of a processor circuitry (e.g., processor circuitry 54 or means for processing 54) of the computer system 500. The processor circuitry 54 or means for processing 54 is to perform a read or write access to the variable if the read or write lock is successfully obtained. For example, a thread of a software program executed by the processor circuitry 54 or means for processing 54 may attempt to obtain the read or write lock to the variable.

FIG. 5b shows a flow chart of a corresponding method for a computer system, such as the computer system 500 of FIG. 5a. The method comprises attempting 510 to obtain a read or write lock for accessing a variable, by performing 515 a write to a lock data structure based on a comparison between the lock data structure and at least one pre-defined condition. The comparison and the write are performed together using a single instruction offered by an instruction set architecture of the processor circuitry of the computer system. The method comprises performing 520 a read or write access to the variable if the read or write lock is successfully obtained. For example, the method may be performed by the computer system 500, e.g., by the apparatus 50 or device 50 of computer system 500.

In the following, the features of the computer system 500, the apparatus 50 or device 50, and of the method of FIG. 5b (and of a corresponding computer program) will be discussed in more detail with reference to computer system 500 and apparatus 50. Features discussed in connection with computer system 500 and apparatus 50 may be likewise included in the corresponding device 50, method of FIG. 5b, and in a corresponding computer program.

The proposed concept is based on manipulating the lock data structure using a single instruction that both a) compares whether the lock data structure adheres to a pre-defined condition (e.g., that the writer counter bit is zero or that the reader counter bit is zero) and b) writes to the lock data structure if the comparison is successful (i.e., if the pre-defined condition is met). In this case, if the comparison is successful and the write is performed, the respective lock (read/write lock) is successfully obtained. This instruction is ideally atomic; that is, the lock data structure cannot be manipulated by a second thread between the comparison and write operation performed by a first thread. Thus, the atomic operation may be performed using an instruction of an instruction set architecture of the processor circuitry for atomically comparing and modifying data. In this context, atomically comparing and modifying data (i.e., the lock data structure) means that the lock data structure cannot be read or manipulated by another thread between the comparison operation and the write operation. In other words, ideally, the comparison and the write are performed together as an atomic operation. Such an operation is the CMPccADDX discussed in US patent publication U.S. Pat. No. 11,036,501 B2. In other words, the atomic operation may be performed using an CMPccADDX instruction. CMPccADDX is an instruction included in some Intel® Instruction Set Architectures (ISAs) that performs a comparison and a conditional addition operation. In particular, CMPccXADD compares an atomic value with a constant and adds a constant to the atomic value if the comparison result is expected. In other words, it compares two values and then adds a third value to a destination register only if a specific condition code (cc) is met. Thus, the atomic operation may be performed using an instruction of an instruction set architecture of the processor circuitry for atomically comparing a first number to a second number and adding a second number to the first number if the comparison may be successful. As an effect, the comparison compares the lock data structure as a number to a threshold number, and the write adds a second number to the lock data structure.

In some examples, the design of the lock data structure is changed to account for the atomic comparison and write operation. In the proposed RW lock (which may include one or more of a basic lock and a fair lock), a new data structure for read/write counters is proposed. This data structure is configured such that the state of the RW lock can be checked and updated in a single atomic instruction.

In the following examples, CMPccXADD is leveraged to update counters more efficiently. However, the proposed concept is not limited to the CMPccXADD instruction. Alternative implementations may use other similar instructions that enable a comparison and manipulation of a lock data structure in an atomic manner.

In the proposed new lock data structure, the key is how to set the value of the threshold and offset. These two values may be defined as a constant in the programs. The threshold may be used to check the state of the RW lock and determine whether the read/write thread can acquire the lock directly or needs to be blocked and wait for the lock to be free. The offset may be used to update the state of read/write counters, such that the state of the RW lock is correct. To define these two values, the structure of the atomic shared variable may be designed carefully.

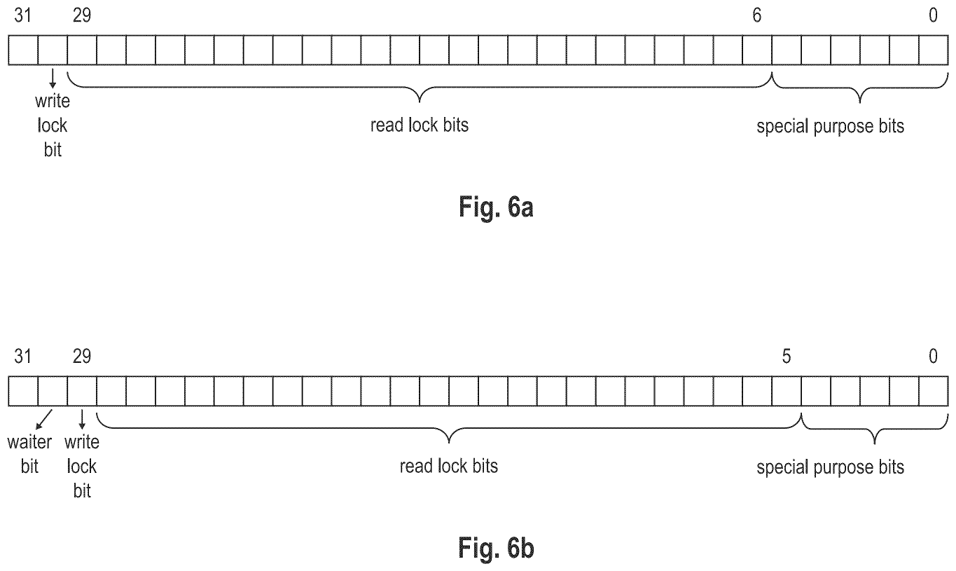

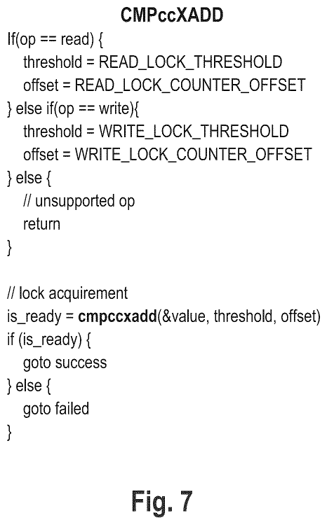

FIG. 6a shows a schematic diagram of a data structure for read/write counters for a basic RW lock. In the basic RW lock, read threads can acquire the lock only if the write counter is zero, namely, no write threads are holding the lock. Write threads can acquire the lock only if both the read counter and write counter are zero. In other words, in case of attempting to obtain a read lock, the comparison may be successful if a write lock bit of the lock data structure has a value (e.g., zero) that indicates that the write lock being set is negative. In case of attempting to obtain a write lock, the comparison may be successful if a write lock bit of the lock data structure has a value that indicates that the write lock being set is negative and if one or more read lock bits (e.g., a read lock counter) of the lock data structure have a value that indicates that the read lock being set is negative (e.g., the read counter is zero).

To utilize CMPccXADD, the modification of special-purpose bits cannot affect the results of the comparison between the threshold and the 32-bit data value. Therefore, the special-purpose bits may be moved to the lowest bits. Moreover, the write lock bit has a higher priority than the read lock bits, as when the write lock bit is 1, each incoming read thread must be blocked. Correspondingly, the threshold and the offset can be defined as follows.

In the exclusive (write) mode, the threshold may be set to (1<<6)-1, and the offset may be 1<<30. If and only if the 32-bit data is not greater than the threshold, the offset may be added to the 32-bit data, and the write lock may be acquired. In FIG. 6a, bits 0 to 5 are special purpose bits, bits 6 to 29 are read lock bits, bit 30 is the write lock bit, and bit 31 is reserved. By setting the threshold to (1<<6)-1 (63), the comparison checks whether any of the read lock bits or the write lock bit is set. If this is the case, the write lock cannot be obtained. By setting the offset to 1<<30, bit 30 is set to 1 (setting the write lock bit to 1) when the comparison is successful.

In the sharing (read) mode, the threshold is (1<<30)-1-((1<<6)-1), and the offset is 1<<6. If and only if the 32-bit data is less than the threshold, the offset is added to the 32-bit data, and the read lock is acquired. In this case, the threshold being set to (1<<30)-1-((1<<6)-1) ensures that the comparison fails if the write bit is set. The offset being 1<<6 means that the read counter is incremented by 1.

In the basic RW lock, the write thread may be starved and waiting for the lock continuously if the read tasks are arriving persistently and the read counter cannot be cleared at all times. To avoid this situation, the fair RW lock is proposed.

FIG. 6b shows a schematic diagram of a data structure for read/write counters for a fair RW lock. In this data structure, bits 0 to 4 are used as special purpose bits, bits 5 to 28 as read lock bits, bit 29 as the write lock bit, and bit 30 as the has-waiters bit. Bit 31 is reserved. When a fair RW lock is used, the RW lock may maintain a waiting list that contains all the blocked threads. Once the lock is free, a blocked thread can be popped from the waiting list and awakened to process the read/write task. The has-waiters bit can represent whether the waiting list is empty. When the waiting list is not empty, all read/write threads that try to acquire the lock have to be blocked. Thus, attempting to obtain a write lock may comprise, if the comparison is unsuccessful, setting a wait bit in the lock data structure to positive and adding a thread attempting to obtain the write lock to a wait list data structure. In addition, the comparison being performed while attempting to obtain a read or write lock may be unsuccessful if the wait bit is set to positive. In other words, compared with the basic RW lock, the fair RW lock has one more condition, which is the has-waiters bit. In this way, the write thread cannot be starved, and the subsequent arrival of read tasks has to wait until the write thread frees the lock. After the read or write threads blocking the next write thread have cleared, the waiting list is used to grant the waiting threads access to the variable. In other words, one or more threads being included in the wait list data structure may be granted access to write to the variable according to the wait list data structure.

Correspondingly, the threshold and the offset may be defined as follows. In the exclusive (write) mode, the threshold may be (1<<5)-1 (to account for the one fewer special purpose bits), and the offset is 1<<29 (to account for the write bit being at bit 29). If and only if the 32-bit data is not greater than the threshold, add the offset to the 32-bit data, and the write lock is acquired. In the sharing (read) mode, the threshold may be (1<<29)-1-((1<<5)-1), and the offset may be 1<<5. If and only if the 32-bit data is less than the threshold, the offset may be added to the 32-bit data, and the read lock may be acquired.

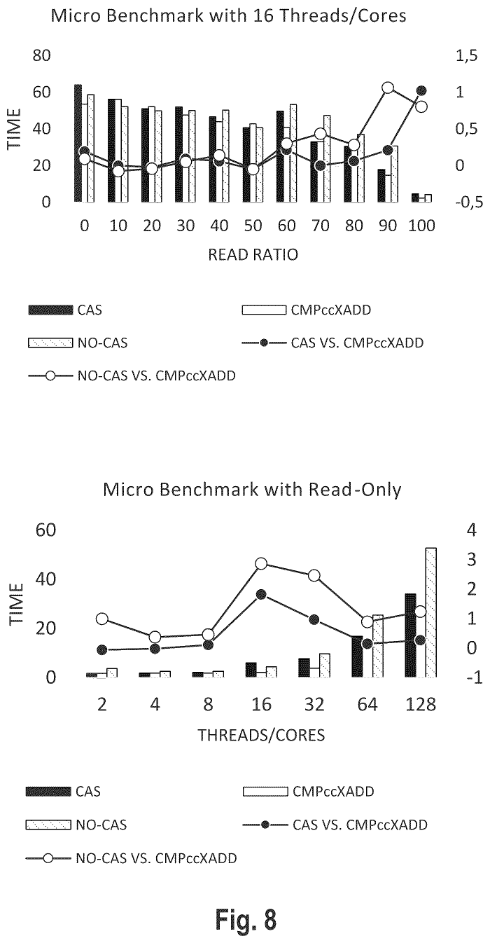

The detailed operations to acquire the RW lock are shown in FIG. 7. FIG. 7 shows pseudocode for acquisition of a RW lock. This pseudocode comprises two parts—the preparation of the threshold and offset, and the actual acquisition of the lock using the cmpccxadd operation, followed by a check to determine whether the comparison was successful.

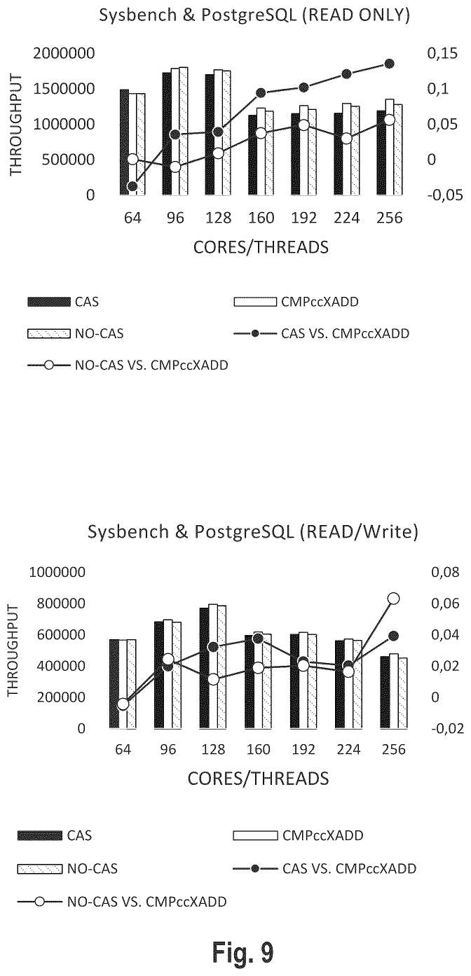

To evaluate the performance and validate the correctness and effectiveness of the proposed RW lock, two experiments have been performed. FIGS. 8 and 9 show diagrams of benchmarks. In the first experiment, a micro-benchmark was developed to evaluate the performance of the primitive. Results of this micro-benchmark are shown in FIG. 8. In the second experiment, all three types of synchronization primitives were applied in the RW lock of PostgreSQL. Sysbench was used to evaluate the performance of the PostgreSQL server. Results of this benchmark are shown in FIG. 9.

The micro-benchmark results are shown in FIG. 8. In the diagram at the top, the number of processor cores and threads is 16. Each thread contends to acquire the RW lock. The total number of locked counts is specific. The ratio of read locks was increased from 0% to 100%, and the total time to finish all lock contention was recorded. It was found that CMPccXADD outperforms the other two, with the improvement being more than 100% in some scenarios. Moreover, as shown in the diagram on the bottom, in the read-only scenario, the number of processor cores was scaled from 2 to 256. When the number of processor cores is more than 128, the performance does not follow a linear improvement with more cores. The use of CMPccXADD improves scalability due to less contention.

PostgreSQL and Sysbench results are shown in FIG. 9. Unmodified, PostgreSQL applies CAS RW lock initially. To evaluate the performance of different RW locks, both NO-CAS and CMPccXADD were implemented in PostgreSQL. All three versions of PostgreSQL were evaluated. When the number of threads and processor cores is less than 64, the RW lock takes only 1% of CPU cycles, and the performance of CAS, NO-CAS, and CMPccXADD are similar. Therefore, only performance data with more than 64 threads is shown. With the increase of threads and cores, CMPccXADD improves performance by up to 5% to 15%. Different from the microbenchmark evaluation, RW lock acquirement takes only 10% of CPU cycles at most, even if the number of cores is 256. When CMPccXADD is applied, the cycles taken by function “LWLockAcquire” are reduced from 10% to 7%. Moreover, the atomic operation CMPccXADD takes almost all the cycles in “LWLockAcquire”. Thus, the effectiveness of CMPccXADD in RW lock is proven. While the overall performance improvement of the CMPccXADD optimization is limited in PostgreSQL, with the increase of cores/threads, RW lock acquirement takes more CPU cycles, and the performance improvement becomes more pronounced.

The proposed concept reduces contention and improves the scalability of the RW lock, which can benefit lots of software, including the Linux kernel, MySQL, PostgreSQL, and so on. It will benefit computer systems with processor circuitry (e.g., a Central Processing Unit) that supports the single instruction for atomically performing the comparison and manipulation of the lock data structure.

More details and aspects of the improved mechanism for acquiring a RW lock are mentioned in connection with the proposed concept or one or more examples described above or below (e.g. FIGS. 1 to 4, 10 to 12). The improved mechanism for acquiring a RW lock may comprise one or more additional optional features corresponding to one or more aspects of the proposed concept or one or more examples described above or below.

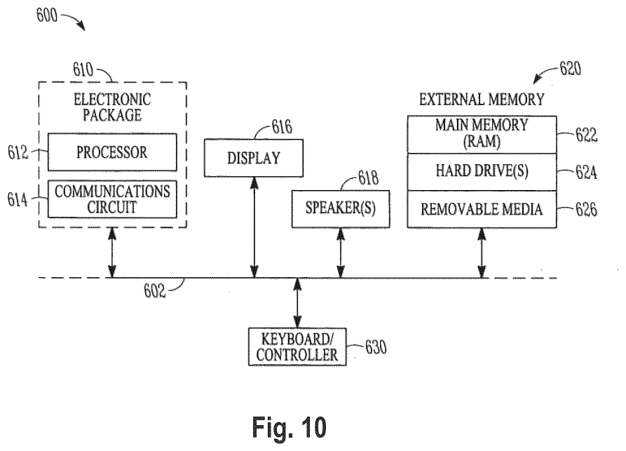

FIG. 10 shows a block diagram of an electronic apparatus 600 incorporating at least one electronic assembly and/or method described herein. Electronic apparatus 600 is merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communication links among the various components of the electronic apparatus 600 and may be implemented as a single bus, as a combination of buses, or in any other suitable manner.

An electronic assembly 610 as described herein may be coupled to system bus 602. The electronic assembly 610 may include any circuit or combination of circuits. In one example, the electronic assembly 610 includes a processor 612 which can be of any type. As used herein, “processor” means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), a multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable for the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

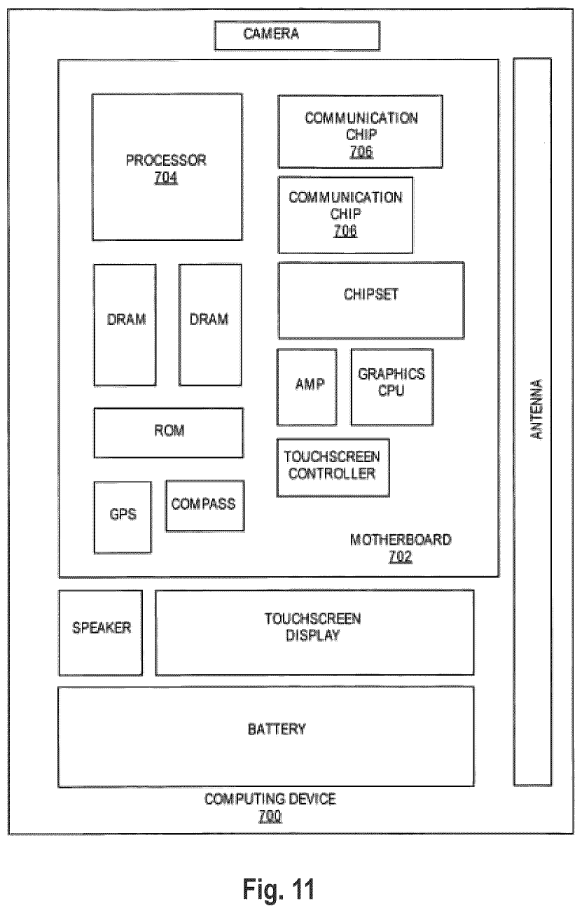

FIG. 11 illustrates a computing device 700 in accordance with one implementation of the proposed concept. The computing device 700 houses a board 702. The board 702 may include a number of components, including but not limited to a processor 704 and at least one communication chip 706. The processor 704 is physically and electrically coupled to the board 702. In some implementations, the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as a hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth, and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. In some implementations of the proposed concept, the integrated circuit die of the processor includes one or more devices that are assembled in an ePLB or eWLB based POP package that includes a mold layer directly contacting a substrate, in accordance with implementations of the proposed concept. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the proposed concept, the integrated circuit die of the communication chip includes one or more devices that are assembled in an ePLB or eWLB based POP package that includes a mold layer directly contacting a substrate, in accordance with implementations of the proposed concept.

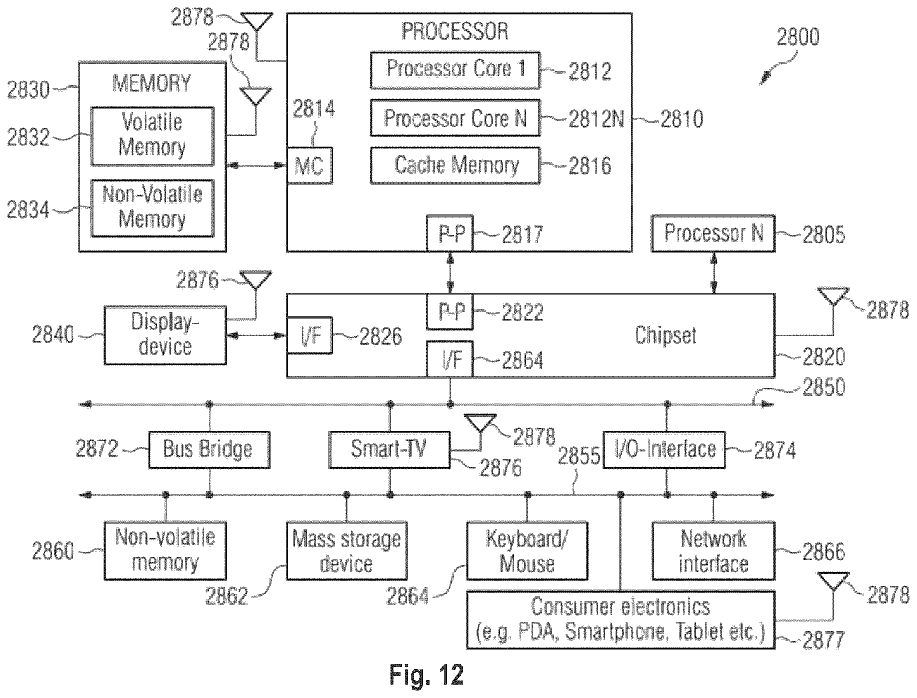

FIG. 12 is included to show an example of a higher level device application for the disclosed examples. In an example, a computing system 2800 includes, but is not limited to, a desktop computer. In an example, a system 2800 includes, but is not limited to a laptop computer. In an example, a system 2800 includes, but is not limited to a netbook. In an example, a system 2800 includes, but is not limited to a tablet. In an example, a system 2800 includes, but is not limited to a notebook computer. In an example, a system 2800 includes, but is not limited to a personal digital assistant (PDA). In an example, a system 2800 includes, but is not limited to a server. In an example, a system 2800 includes, but is not limited to a workstation. In an example, a system 2800 includes, but is not limited to a cellular telephone. In an example, a system 2800 includes, but is not limited to a mobile computing device. In an example, a system 2800 includes, but is not limited to a smart phone. In an example, a system 2800 includes, but is not limited to an internet appliance. Other types of computing devices may be configured with the microelectronic device that includes apparatus or device examples.

In an example, the processor 2810 has one or more processing cores 2812 and 2812N, where 2812N represents the Nth processor core inside processor 2810, where N is a positive integer. In an example, the electronic device system 2800 uses an example of an apparatus, device, or computer system that includes multiple processors including 2810 and 2805, where the processor 2805 has logic similar to or identical to the logic of the processor 2810. In an example, the processing core 2812 includes, but is not limited to, pre-fetch logic to fetch instructions, decode logic to decode the instructions, execution logic to execute instructions, and the like. In an example, the processor 2810 has a cache memory 2816 to cache at least one of instructions and data for the apparatus or device in the system 2800. The cache memory 2816 may be organized into a hierarchical structure including one or more levels of cache memory.

In an example, the processor 2810 includes a memory controller 2814, which is operable to perform functions that enable the processor 2810 to access and communicate with memory 2830 that includes at least one of a volatile memory 2832 and a non-volatile memory 2834.

In an example, the processor 2810 is coupled with memory 2830 and chipset 2820. The processor 2810 may also be coupled to a wireless antenna 2878 to communicate with any device configured to at least one of transmit and receive wireless signals. In an example, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an example, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an example, the memory 2830 may also store temporary variables or other intermediate information while the processor 2810 is executing instructions. In the illustrated example, the chipset 2820 connects with the processor 2810 via Point-to-Point (PtP or P-P) interfaces 2817 and 2822. Either of these PtP examples may be achieved using an apparatus, device, or computer system as set forth in this disclosure. The chipset 2820 enables the processor 2810 to connect to other elements in the apparatus or device within a system 2800. In an example, interfaces 2817 and 2822 operate in accordance with a PtP communication protocol such as the Intel® QuickPath Interconnect (QPI) or the like. In other examples, a different interconnect may be used.

In an example, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least transmit or receive wireless signals.

The chipset 2820 connects to the display device 2840 via the interface 2826. The display 2840 may be, for example, a liquid crystal display (LCD), a plasma display, a cathode ray tube (CRT) display, or any other form of visual display device. In an example, the processor 2810 and the chipset 2820 are merged into an apparatus or device within a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872, such as at least one apparatus or device. In an example, the chipset 2820 couples with a non-volatile memory 2860, a mass storage device(s) 2862, a keyboard/mouse 2864, and a network interface 2866 by way of at least one of the interfaces 2824 and 2874, the smart TV 2876, and the consumer electronics 2877, etc.

In an example, the mass storage device 2862 includes, but is not limited to, a solid state drive, a hard disk drive, a universal serial bus flash memory drive, or any other form of computer data storage medium. In one example, the network interface 2866 is implemented by any type of well-known network interface standard including, but not limited to, an Ethernet interface, a universal serial bus (USB) interface, a Peripheral Component Interconnect (PCI) Express interface, a wireless interface, and/or any other suitable type of interface. In one example, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 12 are depicted as separate blocks within the apparatus or device in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects thereof) can be incorporated into the processor core 2812.

Where useful, the computing system 2800 may have a broadcasting structure interface, such as for affixing the apparatus or device to a cellular tower.

In the following, some examples of the proposed concept are presented:

An example (e.g., example 1) relates to a non-transitory computer-readable medium storing instructions that, when executed by one or more processor circuitries, cause the one or more processor circuitries to perform a method for a computer system, comprising attempting to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system, and performing a read or write access to the variable if the read or write lock is successfully obtained.

Another example (e.g., example 2) relates to a previous example (e.g., example 1) or to any other example, further comprising that the read or write lock is obtained if the comparison is successful and the write is performed.

Another example (e.g., example 3) relates to a previous example (e.g., one of the examples 1 or 2) or to any other example, further comprising that the atomic operation is performed using an instruction of an instruction set architecture of the processor circuitry for atomically comparing and modifying data.

Another example (e.g., example 4) relates to a previous example (e.g., one of the examples 1 to 3) or to any other example, further comprising that the comparison and the write are performed together as an atomic operation.

Another example (e.g., example 5) relates to a previous example (e.g., one of the examples 1 to 4) or to any other example, further comprising that the atomic operation is performed using an instruction of an instruction set architecture of the processor circuitry for atomically comparing a first number to a second number and adding a second number to the first number if the comparison is successful.

Another example (e.g., example 6) relates to a previous example (e.g., one of the examples 1 to 5) or to any other example, further comprising that the atomic operation is performed using an CMPccADDX instruction.

Another example (e.g., example 7) relates to a previous example (e.g., one of the examples 1 to 6) or to any other example, further comprising that the comparison compares the lock data structure as a number to a threshold number, and wherein the write adds a second number to the lock data structure.

Another example (e.g., example 8) relates to a previous example (e.g., one of the examples 1 to 7) or to any other example, further comprising that in case of attempting to obtain a read lock, the comparison is successful if a write lock bit of the lock data structure has a value that indicates that the write lock being set is negative.

Another example (e.g., example 9) relates to a previous example (e.g., one of the examples 1 to 8) or to any other example, further comprising that in case of attempting to obtain a write lock, the comparison is successful if a write lock bit of the lock data structure has a value that indicates that the write lock being set is negative and if one or more read lock bits of the lock data structure have a value that indicates that the read lock being set is negative.

Another example (e.g., example 10) relates to a previous example (e.g., example 9) or to any other example, further comprising that attempting to obtain a write lock comprises, if the comparison is unsuccessful, setting a wait bit in the lock data structure to positive, and adding a thread attempting to obtain the write lock to a wait list data structure, wherein the comparison being performed while attempting to obtain a read or write lock is unsuccessful if the wait bit is set to positive.

Another example (e.g., example 11) relates to a previous example (e.g., example 10) or to any other example, further comprising that one or more threads being included in the wait list data structure are granted access to write to the variable according to the wait list data structure.

Another example (e.g., example 12) relates to a previous example (e.g., one of the examples 1 to 11) or to any other example, further comprising that a thread of a software program attempts to obtain the read or write lock to the variable.

An example (e.g., example 13) relates to a method for a computer system, comprising attempting to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system, and performing a read or write access to the variable if the read or write lock is successfully obtained.

Another example (e.g., example 14) relates to a previous example (e.g., example 13) or to any other example, further comprising that the read or write lock is obtained if the comparison is successful and the write is performed.

Another example (e.g., example 15) relates to a previous example (e.g., one of the examples 13 or 14) or to any other example, further comprising that the atomic operation is performed using an instruction of an instruction set architecture of the processor circuitry for atomically comparing and modifying data.

Another example (e.g., example 16) relates to a previous example (e.g., one of the examples 13 to 15) or to any other example, further comprising that the comparison and the write are performed together as an atomic operation.

Another example (e.g., example 17) relates to a previous example (e.g., one of the examples 13 to 16) or to any other example, further comprising that the atomic operation is performed using an instruction of an instruction set architecture of the processor circuitry for atomically comparing a first number to a second number and adding a second number to the first number if the comparison is successful.

Another example (e.g., example 18) relates to a previous example (e.g., one of the examples 13 to 17) or to any other example, further comprising that the atomic operation is performed using an CMPccADDX instruction.

Another example (e.g., example 19) relates to a previous example (e.g., one of the examples 13 to 18) or to any other example, further comprising that the comparison compares the lock data structure as a number to a threshold number, and wherein the write adds a second number to the lock data structure.

Another example (e.g., example 20) relates to a previous example (e.g., one of the examples 13 to 19) or to any other example, further comprising that in case of attempting to obtain a read lock, the comparison is successful if a write lock bit of the lock data structure has a value that indicates that the write lock being set is negative.

Another example (e.g., example 21) relates to a previous example (e.g., one of the examples 13 to 20) or to any other example, further comprising that in case of attempting to obtain a write lock, the comparison is successful if a write lock bit of the lock data structure has a value that indicates that the write lock being set is negative and if one or more read lock bits of the lock data structure have a value that indicates that the read lock being set is negative.

Another example (e.g., example 22) relates to a previous example (e.g., example 21) or to any other example, further comprising that attempting to obtain a write lock comprises, if the comparison is unsuccessful, setting a wait bit in the lock data structure to positive, and adding a thread attempting to obtain the write lock to a wait list data structure, wherein the comparison being performed while attempting to obtain a read or write lock is unsuccessful if the wait bit is set to positive.

Another example (e.g., example 23) relates to a previous example (e.g., example 22) or to any other example, further comprising that one or more threads being included in the wait list data structure are granted access to write to the variable according to the wait list data structure.

Another example (e.g., example 24) relates to a previous example (e.g., one of the examples 13 to 23) or to any other example, further comprising that a thread of a software program attempts to obtain the read or write lock to the variable.

An example (e.g., example 25) relates to an apparatus for a computer system, comprising interface circuitry, machine-readable instructions, and processor circuitry to execute the machine-readable instructions to attempt to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system, and perform a read or write access to the variable if the read or write lock is successfully obtained.

Another example (e.g., example 26) relates to a previous example (e.g., example 25) or to any other example, further comprising that the read or write lock is obtained if the comparison is successful and the write is performed.

Another example (e.g., example 27) relates to a previous example (e.g., one of the examples 25 or 26) or to any other example, further comprising that the atomic operation is performed using an instruction of an instruction set architecture of the processor circuitry for atomically comparing and modifying data.

Another example (e.g., example 28) relates to a previous example (e.g., one of the examples 25 to 27) or to any other example, further comprising that the comparison and the write are performed together as an atomic operation.

Another example (e.g., example 29) relates to a previous example (e.g., one of the examples 25 to 28) or to any other example, further comprising that the atomic operation is performed using an instruction of an instruction set architecture of the processor circuitry for atomically comparing a first number to a second number and adding a second number to the first number if the comparison is successful.

Another example (e.g., example 30) relates to a previous example (e.g., one of the examples 25 to 29) or to any other example, further comprising that the atomic operation is performed using an CMPccADDX instruction.

Another example (e.g., example 31) relates to a previous example (e.g., one of the examples 25 to 30) or to any other example, further comprising that the comparison compares the lock data structure as a number to a threshold number, and wherein the write adds a second number to the lock data structure.

Another example (e.g., example 32) relates to a previous example (e.g., one of the examples 13 to 19) or to any other example, further comprising that in case of attempting to obtain a read lock, the comparison is successful if a write lock bit of the lock data structure has a value that indicates that the write lock being set is negative.

Another example (e.g., example 33) relates to a previous example (e.g., one of the examples 25 to 32) or to any other example, further comprising that in case of attempting to obtain a write lock, the comparison is successful if a write lock bit of the lock data structure has a value that indicates that the write lock being set is negative and if one or more read lock bits of the lock data structure have a value that indicates that the read lock being set is negative.

Another example (e.g., example 34) relates to a previous example (e.g., example 33) or to any other example, further comprising that attempting to obtain a write lock comprises, if the comparison is unsuccessful, setting a wait bit in the lock data structure to positive, and adding a thread attempting to obtain the write lock to a wait list data structure, wherein the comparison being performed while attempting to obtain a read or write lock is unsuccessful if the wait bit is set to positive.

Another example (e.g., example 35) relates to a previous example (e.g., example 34) or to any other example, further comprising that one or more threads being included in the wait list data structure are granted access to write to the variable according to the wait list data structure.

Another example (e.g., example 36) relates to a previous example (e.g., one of the examples 25 to 35) or to any other example, further comprising that a thread of a software program attempts to obtain the read or write lock to the variable.

An example (e.g., example 37) relates to a device for a computer system, comprising means for processing configured to attempt to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system, and perform a read or write access to the variable if the read or write lock is successfully obtained.

Another example (e.g., example 38) relates to a previous example (e.g., example 37) or to any other example, further comprising that the read or write lock is obtained if the comparison is successful and the write is performed.

Another example (e.g., example 39) relates to a previous example (e.g., one of the examples 37 or 38) or to any other example, further comprising that the atomic operation is performed using an instruction of an instruction set architecture of the processor circuitry for atomically comparing and modifying data.

Another example (e.g., example 40) relates to a previous example (e.g., one of the examples 37 to 39) or to any other example, further comprising that the comparison and the write are performed together as an atomic operation.

Another example (e.g., example 41) relates to a previous example (e.g., one of the examples 37 to 40) or to any other example, further comprising that the atomic operation is performed using an instruction of an instruction set architecture of the processor circuitry for atomically comparing a first number to a second number and adding a second number to the first number if the comparison is successful.

Another example (e.g., example 42) relates to a previous example (e.g., one of the examples 37 to 41) or to any other example, further comprising that the atomic operation is performed using an CMPccADDX instruction.

Another example (e.g., example 43) relates to a previous example (e.g., one of the examples 37 to 42) or to any other example, further comprising that the comparison compares the lock data structure as a number to a threshold number, and wherein the write adds a second number to the lock data structure.

Another example (e.g., example 44) relates to a previous example (e.g., one of the examples 13 to 19) or to any other example, further comprising that in case of attempting to obtain a read lock, the comparison is successful if a write lock bit of the lock data structure has a value that indicates that the write lock being set is negative.

Another example (e.g., example 45) relates to a previous example (e.g., one of the examples 37 to 44) or to any other example, further comprising that in case of attempting to obtain a write lock, the comparison is successful if a write lock bit of the lock data structure has a value that indicates that the write lock being set is negative and if one or more read lock bits of the lock data structure have a value that indicates that the read lock being set is negative.

Another example (e.g., example 46) relates to a previous example (e.g., example 45) or to any other example, further comprising that attempting to obtain a write lock comprises, if the comparison is unsuccessful, setting a wait bit in the lock data structure to positive, and adding a thread attempting to obtain the write lock to a wait list data structure, wherein the comparison being performed while attempting to obtain a read or write lock is unsuccessful if the wait bit is set to positive.

Another example (e.g., example 47) relates to a previous example (e.g., example 46) or to any other example, further comprising that one or more threads being included in the wait list data structure are granted access to write to the variable according to the wait list data structure.

Another example (e.g., example 48) relates to a previous example (e.g., one of the examples 37 to 47) or to any other example, further comprising that a thread of a software program attempts to obtain the read or write lock to the variable.

Another example (e.g., example 49) relates to a computer system comprising the apparatus according to one of the examples 25 to 36.

Another example (e.g., example 50) relates to a computer system comprising the device according to one of the examples 37 to 48.

Another example (e.g., example 51) relates to a computer program having a program code for performing the method of one of the examples 13 to 24, when the computer program is executed on a computer, a processor, or a programmable hardware component.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processor circuitries, cause the one or more processor circuitries to perform a method for a computer system, comprising:
attempting to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system; and
performing a read or write access to the variable if the read or write lock is successfully obtained.

2. The non-transitory computer-readable medium according to claim 1, wherein the read or write lock is obtained if the comparison is successful and the write is performed.

3. The non-transitory computer-readable medium according to claim 1, wherein the atomic operation is performed using an instruction of an instruction set architecture of the processor circuitry for atomically comparing and modifying data.

4. The non-transitory computer-readable medium according to claim 1, wherein the comparison and the write are performed together as an atomic operation.

5. The non-transitory computer-readable medium according to claim 1, wherein the atomic operation is performed using an instruction of an instruction set architecture of the processor circuitry for atomically comparing a first number to a second number and adding a second number to the first number if the comparison is successful.

6. The non-transitory computer-readable medium according to claim 1, wherein the atomic operation is performed using an CMPccADDX instruction.

7. The non-transitory computer-readable medium according to claim 1, wherein the comparison compares the lock data structure as a number to a threshold number, and wherein the write adds a second number to the lock data structure.

8. The non-transitory computer-readable medium according to claim 1, wherein, in case of attempting to obtain a read lock, the comparison is successful if a write lock bit of the lock data structure has a value that indicates that the write lock being set is negative.

9. The non-transitory computer-readable medium according to claim 1, wherein, in case of attempting to obtain a write lock, the comparison is successful if a write lock bit of the lock data structure has a value that indicates that the write lock being set is negative and if one or more read lock bits of the lock data structure have a value that indicates that the read lock being set is negative.

10. The non-transitory computer-readable medium according to claim 9, wherein attempting to obtain a write lock comprises, if the comparison is unsuccessful, setting a wait bit in the lock data structure to positive, and adding a thread attempting to obtain the write lock to a wait list data structure, wherein the comparison being performed while attempting to obtain a read or write lock is unsuccessful if the wait bit is set to positive.

11. The non-transitory computer-readable medium according to claim 10, wherein one or more threads being included in the wait list data structure are granted access to write to the variable according to the wait list data structure.

12. The non-transitory computer-readable medium according to claim 1, wherein a thread of a software program attempts to obtain the read or write lock to the variable.

13. A method for a computer system, comprising:
attempting to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system; and
performing a read or write access to the variable if the read or write lock is successfully obtained.

14. The method according to claim 13, wherein the read or write lock is obtained if the comparison is successful and the write is performed.

15. The method according to claim 13, wherein the atomic operation is performed using an instruction of an instruction set architecture of the processor circuitry for atomically comparing and modifying data.

16. The method according to claim 13, wherein the comparison and the write are performed together as an atomic operation.

17. An apparatus for a computer system, comprising interface circuitry, machine-readable instructions, and processor circuitry to execute the machine-readable instructions to:
attempt to obtain a read or write lock for accessing a variable, by performing a write to a lock data structure based on a comparison between the lock data structure and at least one pre-defined condition, wherein the comparison and the write are performed together using a single instruction offered by an instruction set architecture of a processor circuitry of the computer system; and
perform a read or write access to the variable if the read or write lock is successfully obtained.

18. The apparatus according to claim 17, wherein the read or write lock is obtained if the comparison is successful and the write is performed.

19. The apparatus according to claim 17, wherein the atomic operation is performed using an instruction of an instruction set architecture of the processor circuitry for atomically comparing and modifying data.

20. The apparatus according to claim 17, wherein the comparison and the write are performed together as an atomic operation.
